(19) United States
(12) Patent Application Publication
(10) Pub. No.: US 2026/0250964 A1
(43) Pub. Date: Aug. 27, 2026

(54) Tool for Installing Sheetrock to a Ceiling by a Single Tradesman

(71) Applicant: Donald G. McClain, Whtie Plains, NY (US)

(72) Inventor: Donald G. McClain, Whtie Plains, NY (US)

(21) Appl. No.: 19/059,804

(22) Filed: Feb. 21, 2025

(51) Int. Cl. E04F 21/18; B25B 5/06; B25B 5/16

(52) U.S. Cl. CPC E04F 21/18; B25B 5/067; B25B 5/16

(57) ABSTRACT

An accessory for a C-clamp or an integrated tool comprising a claimping set of jaws for securing the same temporarily to a wood beam ceiling framework which is intended to be covered with sheetrock panels and also comprising a horizontal, supporting ledge or flange element for holding the sheetrock panel proximal to the wood beam so that a single tradesman can install sheetrock panels by him/her self by resting one edge of the sheetrock panel on the ledge or flange while the other end is secured to the framework.

### BACKGROUND OF THE INVENTION

The present invention relates to a tool-like device for allowing a single tradesman, carpenter, or homeowner (hereinafter collectively “a tradesman”) to secure individual panels of sheetrock to the exposed beams of a ceiling which is intended to be covered with the sheetrock panels. Without the present invention it is exceptionally difficult for a single tradesman to simultaneously hold the edge and weight of a part or most of the sheetrock panel up against the exposed beam(s) of a ceiling to be covered with the sheetrock panels and to then secure the same to the beam by use of hammer and nails, screws by use of an electric screw driver, and/or nails with a compressed nail gun. By providing and using the present invention, however, the task of installing a set of sheetrock panels to form a ceiling onto the otherwise exposed parallel wood beams of a ceiling to be covered by the sheetrock, is quick, accurate and easy. It is a vast improvement and allows a solo tradesman or worker to cover an entire ceiling with sheetrock panels, with hammer and nails or with the use of fasteners via a compressed nail gun or screwdriver, in a minimum of time and with relative ease. It is a labor and cost saving tool.

The present invention is a specially designed tool, wherein one, possibly two or more are simultaneously used for each panel to be secured, which tools are first easily clamped and held to the exposed parallel beams and, when so secured, the clamp(s) provide a horizontal support surface like a ledge for support of the far edge of the sheetrock panel which allows the tradesman to easily raise and secure the adjacent or another edge to the beam by use of conventional fastening, screws, nails, etc. The use of the present invention is easy, quick, accurate, inexpensive and highly time and labor saving as it allows, as mentioned, a single tradesman to secure sheets and panels of sheetrock to a ceiling (provided with exposed and parallel beams).

The present invention comprises, basically, an adjustable clamping mechanism (either of a trigger/ratchet claim and the traditional C-claim type having a screw passing through an opposed interior threaded screw hole, by use of a rotatable handle to allow for adjustment and securement of the C-clamp to the wood beam. Alternatively a single-hand ratchet clamp can be used for holding the clamp to the beam. By use of a clamp with the present accessory or a new tool comprising the clamp and a ledge member, panels of sheetrock can be secured to the otherwise exposed wood beams of a framework. The clamps will be located at spaced intervals on a beam, just like any wood clamp (of the C-type whether of the traditional C-clamp with a large screw pulling the ends towards one another or of the more recently made ratcheted and trigger activated clamps (for example bade by DeWalt and other makers). The clamps can adjust to the width of the wood beams and can be selectively and removably attached to a piece of wood. This can be done with a simple elongated screw passing through aligned internal screw threads of the clamp (as conventionally done in C-clamps) or by a trigger-like ratcheting mechanism (o the DeWalt type) which squeezes the jaws of the clamp until resistance is met and holds the clamp onto the wooden beam. The type, maker and mechanism for the clamp is not important, rather, what is important to the present invention is holding the clamp to the wood beam and providing, at the clamp, a horizontally extending holding ledge for one end/edge or corner of the sheetrock panel. This holding mechanism, i.e., the ledge, supports the sheetrock panel while allowing the tradesman to go to the other edge of the panel of sheetrock and secure it to the parallel and exposed wood beam. The securement of the clamp to a beam in the ceiling having a laterally extending ledge is used for providing a support ledge or support surface for the panel of sheetrock, and that allows the adjacent or opposed edge of the same panel of sheetrock to be secured to the parallel wood beam with nails or screws. Once it is secured, the tradesman can push upwardly on the panel which was laying upon the ledge or support surface (attached to the clamp) and then secure that edge with screws or nails. In this manner, the entire panel can be secured to a parallel wood beam structure and then panel by panel can be secured to create a complete ceiling of secured to wood beams, sheetrock panels. All being easily capable of being erected by a single tradesman.

Once panels are secured, the job is finished and has been accomplished by a single tradesman. The present invention is a new tool (wood clamp and extending ledge) and/or tool accessory for adapting onto a C-clamp. It can either be a newly made clamp and integrated support ledge device or a piece of sheet-like metal which cooperates with pre-existing and ordinary C-clamps, with the sheet-like metal attaching to or extending over the C-clamp and providing a support surface or ledge for the edge of the sheetrock panel.

Extending outwardly, however, from the ends of the clamp surrounding the wood beam, in either embodiment, is a horizontal support surface, like a flange element, which extends from the tool, the tool attachable to the beam, and extends toward the opposed and parallel beam. That basically horizontal support surface or flange support element can support one edge or corner of the sheetrock. Two or more clamps can be used to support the first edge of the panel and the other edge first secured to the wood beam. Then, the clamps are removed and the edge of the panel which were supported by the ledges of the clamps can be easily pushed upwardly and secured to the beam. That is because the edge originally resting or supported upon the ledge is closely held proximal to the beam to which it can easily be pushed up upon for securement to the wood beam. One edge of the sheetrock is thus first placed on those aligned flanges and when the opposed edge is secured, the edge of the panel supported by the ledges, i.e., the sheetrock is lifted upward on it opposed edge and “held” and then secured by nails or screws. One the first edge is secured, then, the other edge, first supported by the flanges of the tool/sheet metal accessory to the C-clamp, is secured to the beams, with screws and/or nails. In this manner, a ceiling comprised of sheetrock panels can be quickly, easily, and inexpensively secured to a frame of beams in a ceiling. All by a single tradesman.

### DESCRIPTION OF THE PRIOR ART

The prior art basically comprises, to the inventor’s knowledge, the use of two tradesmen to support a single sheetrock panel (normally about 4 feet by 8 feet, in a variety of thicknesses, ranging from ¼ inch up to ¾ inch, with most residential sheetrock being about four feet by eight feet and about ⅝ inch in thickness). Once the two tradesmen lift and support the single panel up towards the ceiling, covered with a set of parallel and spaced apart beams (usually 16 inches on center) the process of using the compressed nail gun or electric screw driver will be commenced with the nails (up to their heads) passing through the sheetrock and into the bottom edge of the beam, to thereby secure a first corner of sheetrock to the beam, then another opposed corner, on the same or the opposed beam, then completing all four corners and then along both of the long edges of the panel into the beam, then the other edge of the panel into the opposed beam, and so forth, until the entire sheetrock panel is properly secured to the pair of opposed and separated beams, with the short edges also then secured in place to the intermittent beams. Once secured, the panel can be further secured by nails or screws passing through and into the other beams of the framework. The entire process is simple with two tradesmen as they move quickly, usually on ladders, to hold and secure the panels to the beams while an opposed edge is secured by one tradesman while the other pushes the panel upwardly to hold the sheetrock in place against the bottom edge of the beam. This is the prior art, known to the present invention. It basically requires a pair of tradesmen working together.

The present invention is a vast improvement over the prior art. A single tradesman can now erect an entire ceiling of sheetrock onto a set of parallel framed beams by using a set of the tools disclosed herein, each basically comprising a wood beam clamp with an outwardly extended flange or support for a corner or edge of the panel of sheetrock. When the sheetrock is hoisted onto a flange, for example, of two such clamps with the ledges of the present invention, it is quite easy for the single tradesman to push up on the opposed edge of the sheetrock panel to place that portion of the sheetrock against the bottom of another beam and then to use a compressed nail gun or electric screw driver to drive a nail(s) or screw(s) through the panel and into the beam. Once that edge is secured, the tradesman can go to the edge supported by the ledge/flange and push it up to the bottom of the beam (it is supported only a few inches below the beam by the location of the flange, clamped to that beam) and then secure the rest of the panel of sheetrock ointo the beam. The tradesman, acting alone, can easily, quickly, accurately and without added labor expense, install sheetrock panels onto the exposed beams of a ceiling to create a complete finished ceiling, ready for spackling, taping, and then painting.

### BRIEF DESCRIPTION OF THE INVENTION

The present invention is preferably provided in either one or two preferred embodiments. In the first embodiment, a traditional C-claim (with rotating screw passing through a threaded bore which brings the clamping heads towards one another) for securing to multiple wood beams can be supplied with a sheet metal accessory. In this embodiment, the C-clamp is secured to an exposed beam of wood on the ceiling and the sheet metal accessory is secured via an opening thereof over the head of the C-clamp and it then extends down and provides a horizontal ledge or flange support surface proximal to the clamp. It is that support surface, extending basically parallel to the bottom edges of the framework for the ceiling (or horizontally) upon which the first edge of the sheetrock panel is slid into place and there held. Then, the tradesman, on a ladder at the opposed edge of the sheetrock panel from that which is supported by the ledge, secures that opposed and free edge to the support framework using nails or screws. Once that edge of the panel is secured to the beam, the tradesman can go back to the first edge of the panel which is supported near to the beam of wood by the ledge of the clamp segment of the device, and secure that edge to the beam with screws or nails. Additional nails and/or screws can be installed to secure the sheetrock panel to several of the beams forming the wood framework of the ceiling. The entire ceiling can be built quickly and with a single person using the present invention.

In an alternate embodiment of the invention, the C-clamp comprises a single-hand triggering and ratcheting device for holding the same to the wood beam and that device has an integrated lateral extension, a ledge or horizontal support surface for the first edge/corner of the sheetrock panel. In this embodiment, the trigger mechanism allows for easy securement of the C-clamp to the wood beam by the ratchet mechanism which closes and holds the jaws of the clamp about the beam as the handle of the tool is successively pulled and released. That tool or C-clamp is provided, according to this embodiment of the invention, with the horizontal ledge for supporting the sheetrock panel proximal to the beam to which it will be secured. After securement of the panel, the C-clamp is easily removed by a release mechanism associated with the ratcheting holding aspect of the C-clamp. A complete ceiling of sheetrock can be quickly, easily installed by a single tradesman.

### BRIEF DESCRIPTION OF THE DRAWING

FIG. 1 is a first side perspective view of the metallic or plastic accessory tool device for use with a C-clamp of conventional structure for use in installing sheet rock by a single tradesman onto a wooden beam support/frame structure in a ceiling;

FIG. 2 is the second side perspective view of the metallic or plastic accessory tool device shown in FIG. 1;

FIG. 3 is a top plan view of the accessory tool device shown in FIGS. 1 and 2;

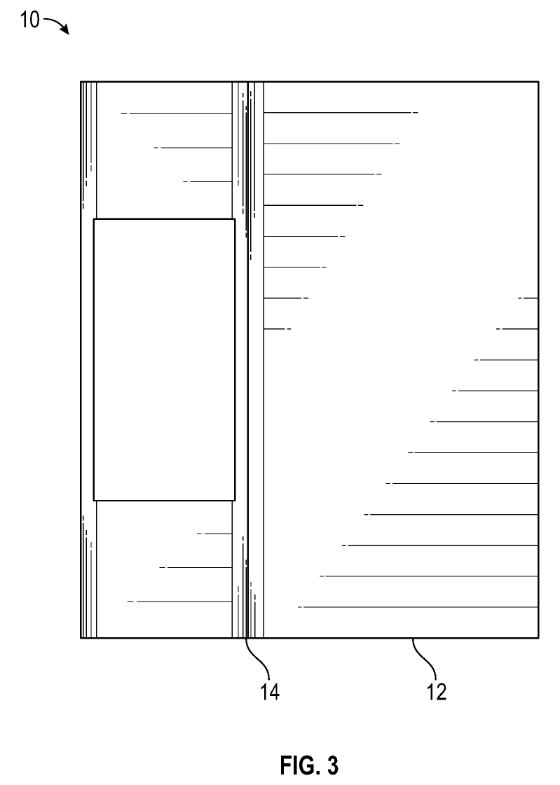

FIG. 4 is a side elevational view of the accessory tool device shown in FIGS. 1, 2, and 3;

FIG. 5 is the opposed side elevational view of the accessory tool device to that shown in FIG. 4;

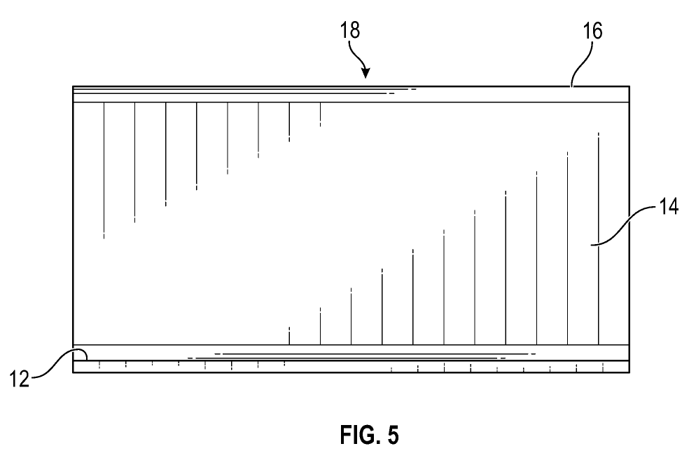

FIG. 6 is a side perspective view of the accessory tool device shown in FIGS. 1-5, as installed over the body of a ratcheted C-clamp which has a pair of opposed wood-engaging surfaces, pulled towards one another as the handle/trigger of the C-clamp is repeatedly pulled;

FIG. 7 is the opposite side, perspective view of the accessory tool device shown installed over the body of the C-clamp of (as in FIG. 6) but showing how a tradesman’s hand can pull the trigger to move the wood-engaging surfaces towards one another to clamp the same onto a beam or frame of wood in a ceiling to which a panel of sheetrock is intended to be secured;

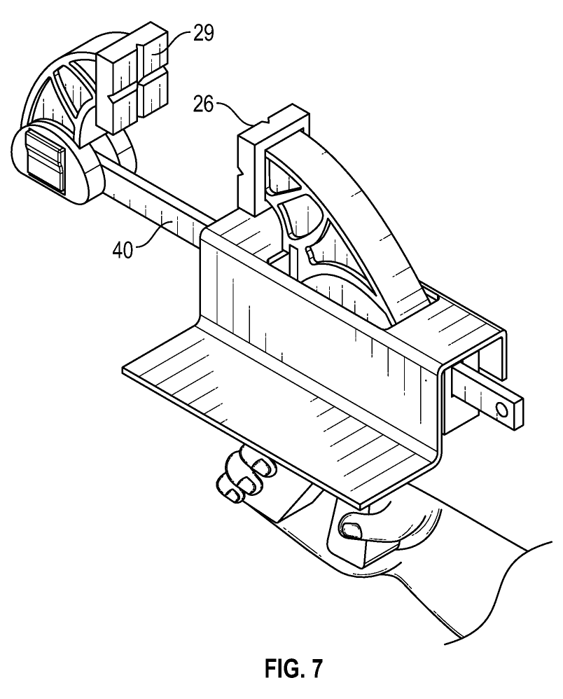

FIG. 8 is a side view of the accessory tool device showing the three right angle bends of the same into a single sheet of material (metal or plastic).

FIG. 9 is a second preferred embodiment of the present invention, showing in side and rear perspective a new, disassembled, a pair of opposed wood engaging clamping surfaces for the tool, comprising a trigger ratcheting clamp for securing the same to a wood beam and an ledge or horizontal support element for the sheetrock panel and

FIG. 10 is side view of the invention shown in FIG. 9, as secured to a beam of wood, with the support shelf or ledge shown as it is supporting an edge of a panel of sheetrock, as the other edge or end of the sheetrock is being lifted by hand to secure the same into another wood beam with screws or nails.

### DETAILED DESCRIPTION OF THE DRAWING FIGURES, THE INVENTION AND THE PREFERRED EMBODIMENTS

According to a first preferred embodiment, a tool accessory is provided which easily cooperates with a conventional wood joining C-Clamp of the screw type, i.e., a pair of opposed surfaces move towards one another as a screw with a turnable bar passing through a hole extending across and through the screw is rotated with the screw passing through a threaded bore. The turning of the bar will cause the screw to rotate within the threaded bore and that brings the distal movable surface towards the non-movable surface until the two surfaces compress around the wood or other structure. This type of C-clamp is very well known.

According to the present first preferred embodiment of the invention, a sheet of metal, plastic, aluminum, etc. is provided of about ⅛ inch in thickness, with three right angle bends and a preferably 2” x 5” rectangular-shaped hole. The metal or aluminum or plastic sheet is proportioned and shaped to cooperate with the C-clamp. This is the “body” of the tool accessory, i.e. a component for use with a wood-clamping C-clamp of the screw turning within a bore type. The first right angle bend provides the horizontal shelf or ledge (with respect to the side or face of the C-clamp), or support for the edge of the sheetrock panel. The second right angle bend is the face-riser to the shelf support and forms one side of the hook or free end of the clamp. The third right angle bend supports the accessory on the C-clamp and is the other side of the hook of the clamp (all as seen in the Figures). The 2” by 5” rectangular shaped hole is provided for the clamp tool and it is through that hole that the C-clamp’s head is passed.

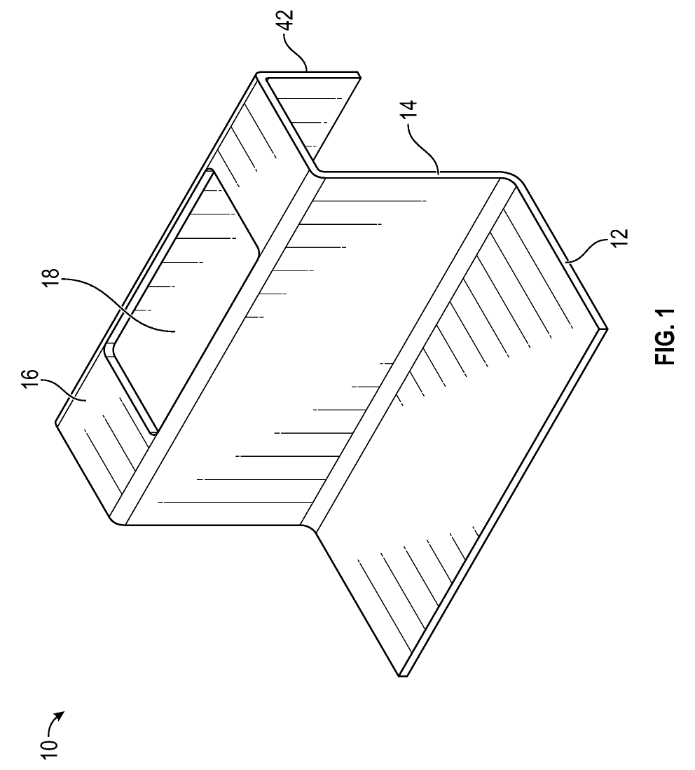

As seen in FIG. 1, the tool accessory 10 for a conventional C-clamp comprises a flat surface 12, forming a ledge or horizontal support surface for a portion of the edge of a sheetrock panel. Its front and back dimension extends about 8 to 10 inches, with a depth of about 3-5 inches (preferably 3 inches) and a thickness of about ⅛ of an inch. That horizontal support surface 12 forms a right angle with a vertical element 14, also about ⅛ inch in thickness and extending along the length of the flat surface 12 and upwardly also about 3 inches. This is the riser or face plate 140 of the accessory 10.

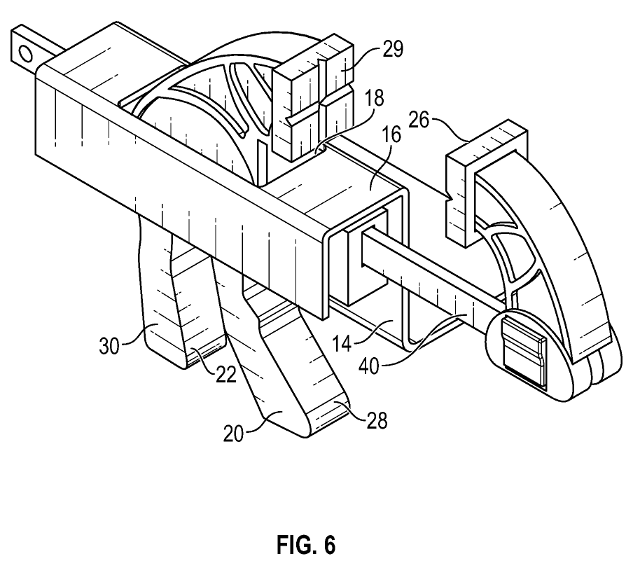

The riser or face plate or vertical element 14 then turns at another right angle to a top element 16, about ⅛ inch in thickness, extending front to rear of the flat surface 12 and riser 14, but with a hole 18 centrally located along its length. The hole 18 is sized to fit over (See FIG. 6) the handle and trigger end 20 of a C-clamp 22 of the ratcheting type whereby two opposed flat surface, wood gripping members 24, 26 will move (26 towards 24) when the handle end is gripped by a tradesman and the handle with finger grips 28 reciprocated with respect to the palm end 30 of the handle end 20. The palm end 30 and the handle with finger grips 28 are hinged together in a well known manner such that pulling on the finger grips 28 will move the bar 40 with its end 26 towards the relatively stationary flat surface, wood gripping member 24. The hole 18 fits over the stationary end of the C-clamp, as shown in FIG. 6. The bar 40 will support the top element 16 of the sheet metal and the bar can move beneath the top surface 16 as the bar is reciprocated by pulling upon the finger grips 28 of the trigger against “stationary” holding of the palm end 30 of the handle end 20.

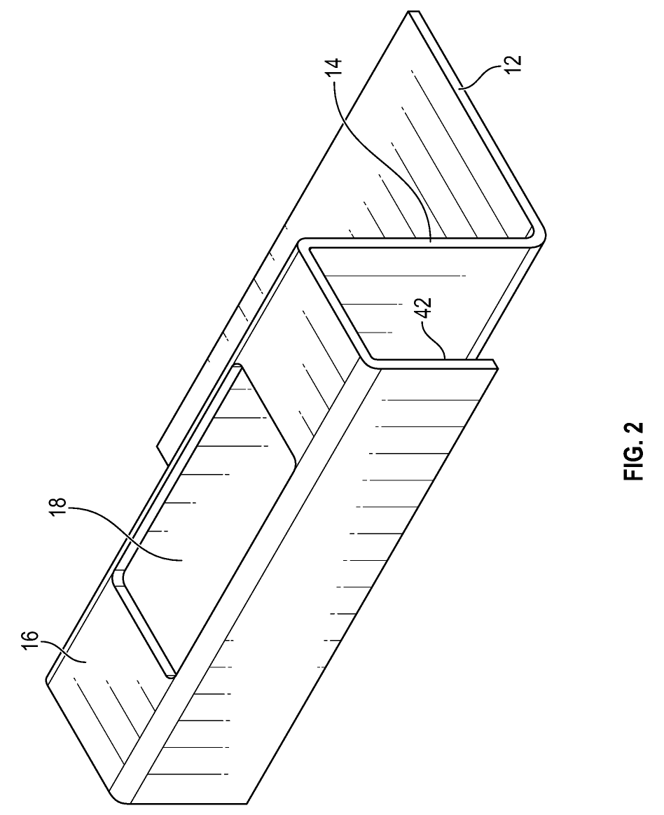

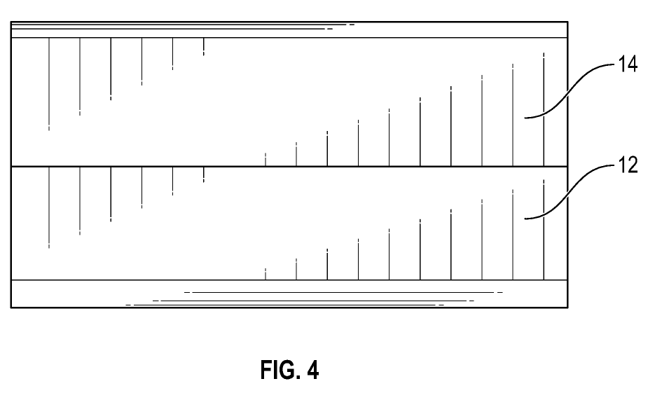

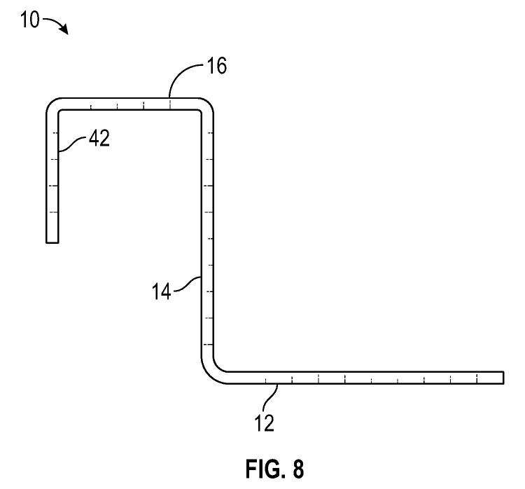

As seen in FIGS. 1, 2, 4, and 6, the tool accessory 10 has a final face, extending vertically downwardly, from the top element 16. This small wall 42 extends (as seen in FIG. 6 and 8) at a right angle to the top element 16, and it, too, can extend along the length of the tool accessory. It, with the top element 16 and the rear surface of the riser 14, extends up and over the C-clamp as the riser, the top element and the small wall 42 form a U-shaped cap for somewhat enclosing or encircling the bar 40 and the hinged connection of the ratchet aspect of the C-clamp.

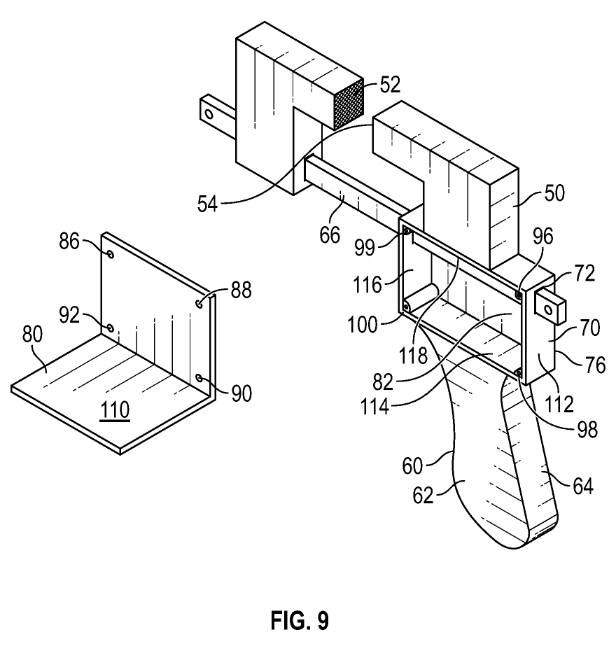

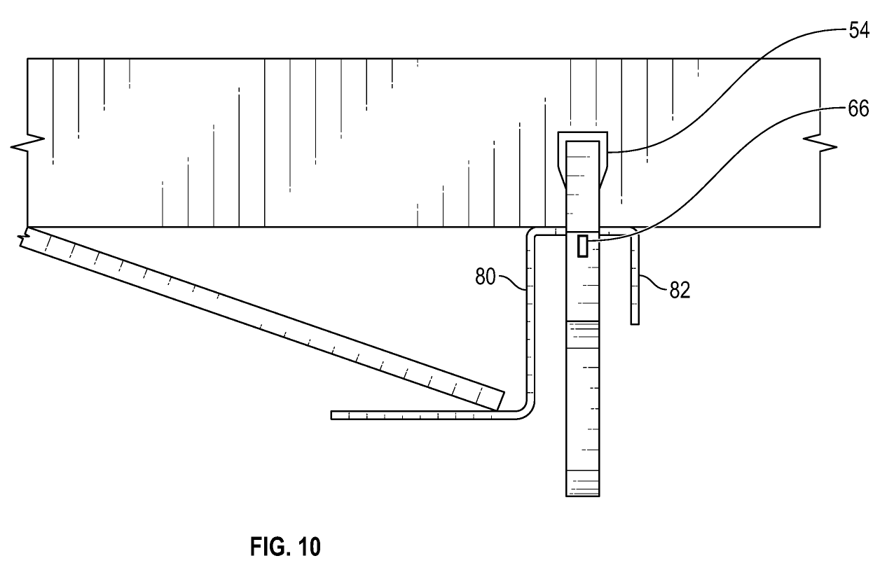

The second and preferred embodiment of the present invention is shown in FIGS. 9 and 10. There, the support plate for the sheetrock panel is integrated into the clamping component of the tool. As seen in the Figs. a clamping tool 50, is provided with a pair of opposed wood beam contact surfaces 52, 54 which are reciprocated toward one another in a ratchet-like manner by mechanical pulling and releasing by the user of the trigger mechanism 60 which is spring-biased outwardly (for repeated depression of the finger engaging component 62 of the C-clamp). Here, too, a palm engaging rear 64 is provided, as expected, to allow for the ease of reciprocation by pulling on the finger engaging component 62 and releasing and repulling the same. And, of course, this mechanism is provided with a release lever (not shown) for allowing ease of reverse movement, i.e., allowing the user to release the clamp for removal of the same from the support wood framework, when desired (after the sheetrock panel is secured upwardly to the wood beam framework). A connecting bar 66 is provided to secure to the wood beam contact surface 52 which is pulled through the rear end 70 when reciprocation of the trigger mechanism 62 occurs. This moves the wood beam contact surface 52 towards wood beam contact surface 54 to clamp the device around the two opposed ends of a wood beam. A slot 72 and opposed slot 74 is provided into the case 76 of the device 50 to allow for the bar to slide and move laterally and to draw the two wood beam contact surfaces 52 and 54 towards one another as the trigger is repeatedly pulled, released, and repulled.

The case 76 is provided with a front cover element 80 and a rear cover 82. Front cover 80 has a vertical plate element 84 with screw holes 86, 88, 90 and 92 which are spaced and provided for screws (not shown) which are accepted by threaded screw holes 94, 96, 98 and 100 to close the cavity of the tool. The screws pass through the screw holes 86, 88, 90 and 92 and into the holes 94, 96, 98, and 100,, respectively. Extending outwardly, at about a right angle to the front cover 80 and providing the ledge or flange for the sheetrock panel is flange 110. Preferably it is about 3 inches in depth, about ⅛ inch in thickness and about 4 inches in width, covering the cavity formed by the side walls 112, 114,116, and 118 and the front cover element 80 and rear cover 82. This flange is basically perpendicular to the axis of the bar 66 and thus to the holding of the clamp to the wood beam. It will be appreciated that the securement of the clamp to a wood beam provides a proximal support ledge or surface (a flange) for a corner or edge of a sheetrock panel. The flange basically extends outwardly from the axis of securement of the clamp and provides a proximal support surface for the edge or corner of the sheetrock panel.

In use, either of the two preferred embodiments can be used by a single tradesman to erect and install sheetrock panels onto exposed wood beams, using screws or nails to hold the sheeterock to the wood beam framework, – to form a finished ceiling of sheetrock panels. The difference in the embodiments is primarily that in one embodiment, an accessory for an existing tool is provided while in the second embodiment, a new tool is presented. However, both versions of the invention contemplate a wood clamp for securement to a wood beam of a ceiling and a support ledge or flange for the sheetrock panel, proximal to the beam to which the panel will be secured to and extending outwardly, likely somewhat horizontally to secure the panel while the other edge or corner is being secured.

The following steps can be accomplished by the tradesman for efficiency. First, if the first embodiment is used, the accessory is installed over one end of the expanded head of a traditional C-clamping mechanism or even a C-clamp of the trigger type. This is done by placing the hole of the device over the open end and the top side of the clamp with the ledge extending toward and behind the stationary clamping end, as seen in FIG. 6. When so arranged the wood contacting ends of the accessory and clamping device are reciprocated to secure the device to a wood beam. If the device is a newly created tool, as shown in FIGS. 9, it, too, will be used to hold the device with its supporting ledge, to a wood beam. Then, once secured, the tradesman will go to the parallel wood beam located about a panel’s width away and lift and slide the sheetrock panel so that it slides into and onto the ledge of the accessory or that of the new tool. With the sheet rock’s panel’s other edge supported on the ledge(s) of the accessory or tool, the tradesman can lift up the free end of the panel with one hand and use his other hand to use an electric screwdriver or pneumatic drill device to screw or nail the first corner of the sheetrock panel to a beam. The tradesman will locate his ladder to the edge or corner of the panel not being supported on the flange(s) and secure the free end of the panel to the framework. Then, the ladder will be moved to being beneath the side/edge of the panel being supported close to the beam by the ledge of the accessory and/or tool, and then secure that corner and edge of the panel to the beam. That is done by pushing upwardly on the panel so that it is pushed against the wood framework and then secured in place. The use of the flange supports to a great extent the weight of the panel and holds it substantially near to the beam to which it will be secured after the first edge (not supported by the ledge) is first secured to the framework. With that entire first side or edge of the panel secured to the frame/beam, the side of the sheetrock panel being supported by the accessory/tool’s ledge or support flange is gently and easily lifted up so that it is in contact with the beam to which it should be supported. It then, with the hands of only that tradesman, can be lifted upwardly and using a screw driver or pneumatic driver of screws or nails, the panel can be secured to the wood beam or ceiling framework.

The spaces and beams between the now secured corners can be “filled” in with further screws and/or nails for total support of the sheetrock panels to the framework. Of course, as the panel is secured in place, the accessory or tool can and should be removed from the beams and used elsewhere or stored away for another ceiling installation.

I claim:

1. An accessory device for use with a C-shaped clamp tool for installing, by a single tradesman, a sheetrock panel onto wood ceiling framework, said C-shape clamp tool comprising a removable clamping means for temporarily securing the clamp tool and accessory device to the wood ceiling framework, said accessory device comprising a laterally extending supporting flange disposed at an angle with respect to said wood ceiling framework when said device is secured to said framework, to provide a support for an edge of a sheetrock panel placed on said flange and to hold the same proximal to said wood ceiling framework.

2. An accessory device as claimed in claim 1 wherein said accessory device comprises a single sheet of material bent to provide said flange and a U-shaped cavity to hold said accessory device to said C-shaped clamp.

3. An accessory device as claimed in claim 1 wherein said flange is bent from a single piece of metal and said metal is further formed with a U-shape in cross section and having a hole in the bight of said U-shape for acceptance of an end of said clamp tool.

4. An accessory device as claimed in claim 2 further comprising a hole in said U-shaped cavity which fits over one end of said C-shaped clamp.

5. A device as claimed in claim 2 wherein said single sheet of material is metal and about ⅛ inch thick.

6. A device as claimed in claim 2 wherein said single sheet of material is stiff plastic.

7. A device as claimed in claim 2 wherein said device is formed by three right angle bends in said single sheet of material.

8. A device as claimed in claim 2 wherein the length of said flange is about 8 inches.

9. A device as claimed in claim 1 wherein said flange project about 3 inches.

10. A device as claimed in claim 1 wherein said flange, when supplied with a sheetrock panel thereon, supports said sheetrock panel about 3 inches from said wood beam framework.

11. A tool for helping to install, by a single tradesman, a sheetrock panel onto wood ceiling framework, comprising a removable yet selectively securable wood ceiling framework clamping component and a laterally extending supporting flange projecting substantially horizontally from said tool which, when said clamping component is secured to a wood ceiling framework, projects said flange outwardly and proximal to said wood ceiling framework for temporarily holding at least a corner or edge of a sheetrock panel near to said wood ceiling framework.

12. A tool as claimed in claim 11 wherein said clamping component is a C-clamp with a one-hand trigger mechanism for closing the opposed ends of said C-clamp towards one another and said flange is bent from a single piece of metal at a single right angle to extend from a side of said C-clamp.

13. A tool as claimed in claim 11 wherein said clamping component comprises a C-shaped clamp mechanism having two opposed wood securing clamping ends with a hand operated ratcheted mechanism for moving at least one of said opposed wood securing clamping ends toward said other end.

14. A tool as claimed in claim 13 wherein said hand operated mechanism is a ratcheted trigger-like mechanism allowing for a single hand to operate the same for clamping to said wood ceiling framework.

15. A tool as claimed in claim 11 wherein said flange extends about 3 inches laterally from the C-shaped clamping mechanism.

16. A tool as claimed in claim 11 wherein said flange extends about three to five inches downwardly and outwardly in both directions from said C-shaped clamping mechanism.

17. A tool as claimed in claim 11 having a single hand operated ratcheted trigger mechanism for closing together the wood clamping ends of said C-shaped clamping mechanism.
